(19) United States
(12) Patent Application Publication
(10) Pub. No.: US 2016/0275348 A1
(43) Pub. Date: Sep. 22, 2016

(54) LOW-POWER IRIS AUTHENTICATION ALIGNMENT

(71) Applicant: Motorola Mobility LLC, Chicago, IL (US)

(72) Inventors: Jiri Slaby, Buffalo Grove, IL (US); Rachid M. Alameh, Crystal Lake, IL (US)

(21) Appl. No.: 14/660,150

(22) Filed: Mar. 17, 2015

(51) Int. Cl. G06K 9/00

(52) U.S. Cl. CPC G06K 9/00604

(57) ABSTRACT

In embodiments of low-power iris authentication alignment, a mobile device includes one or more dual-mode LEDs that is implemented for low-power illumination and high-power illumination. An eye location module can initiate the dual-mode LEDs for the low-power illumination to illuminate the face of a user of the mobile device. The eye location module can detect an alignment of the face of the user with respect to the mobile device, and determine a correct alignment for iris authentication based on the detected alignment of the face of the user utilizing the low-power illumination. The eye location module can then switch one or more of the dual-mode LEDs for the high-power illumination to illuminate of an eye (or both eyes) of the user based on the determination of the correct alignment, and activate an imager to capture an image of the eye (or eyes) of the user for iris authentication.

### BACKGROUND

Portable devices, such as mobile phones, tablet devices, digital cameras, and other types of computing and electronic devices can typically run low on battery power, particularly when a device is utilized extensively between battery charges and device features unnecessarily drain battery power. For example, some devices may be designed for various types of user authentication methods to verify that a user is likely the owner of the device, such as by entering a PIN (personal identification number), or by fingerprint recognition, voice recognition, face recognition, heartrate, and/or with an iris authentication system to authenticate the user. Iris recognition is a form of biometric identification that uses pattern-recognition of one or both irises of the eyes of the user. Individuals have complex, random, iris patterns that are unique and can be imaged from a distance for comparison and authentication.

However, some of the authentication methods utilize the battery power of a device, and some may unnecessarily drain the battery power. For example, an iris authentication system may activate to illuminate the face of a user, and an imager activates to capture an image of the eyes of the user, even when the device is not properly orientated or aimed for useful illumination and imaging. Iris acquisition and subsequent authentication performance can differ depending on the eye illumination quality. Further, an iris authentication system has relatively high power requirements due to near infra-red (NIR) LED and imager use, yet presents advantages over the other authentication methods, such as security level, accuracy, potential for seamless use, and use in many environments (e.g., cold, darkness, bright sunlight, rain, etc.). Iris acquisition and authentication utilizes reflected near infra-red (NIR) light (e.g., from LEDs) to locate an eye of a user and then image the iris of the eye. The NIR illumination is used to image the iris of an eye, but utilizes device battery power to generate the NIR illumination, image the iris, and compare the captured image for user authentication.

### BRIEF DESCRIPTION OF THE DRAWINGS

Embodiments of low-power iris authentication alignment are described with reference to the following Figures. The same numbers may be used throughout to reference like features and components that are shown in the Figures:

FIG. 1 illustrates an example mobile device in which embodiments of low-power iris authentication alignment can be implemented.

FIG. 2 further illustrates examples of low-power iris authentication alignment in accordance with one or more embodiments.

FIG. 3 illustrates example method(s) of low-power iris authentication alignment in accordance with one or more embodiments.

FIG. 4 illustrates various components of an example device that can implement embodiments of low-power iris authentication alignment.

### DETAILED DESCRIPTION

Embodiments of low-power iris authentication alignment are described, such as for any type of mobile device that may be implemented with an infra-red (IR) processing system that is utilized for gesture recognition and/or iris authentication of a user of the mobile device. Typically, an IR system can detect the presence of a user and activate a high-power LED system and an imager to capture an image of the face of the user for iris authentication. However, activating a high-power illumination system and an imager can unnecessarily drain the battery power of a mobile device if the device is not positioned in front of the face of the user and correctly aligned for the illumination and imaging.

In aspects of low-power iris authentication alignment, a mobile device can use dual-mode LEDs for low-power illumination and proximity sensing until a correct alignment of a user is detected in front of an imaging system of the device. An alignment indication can also be displayed on the mobile device to indicate a direction to turn the device and assist a user with achieving a correct alignment of the face of the user with respect to the mobile device so that an image of an eye (or both eyes) of the user can be captured for iris authentication. When a correct alignment of the user with the imager of the device is detected, the device can then switch one or more of the dual-mode LEDs for high-power illumination of the face of the user, and activate the imager to capture the image of the eye (or eyes) of the user for iris authentication. Although described primarily for iris authentication, the techniques described herein are applicable for face recognition and/or authentication, as well as for other similarly-based authentication methods and systems.

These features of low-power iris authentication alignment conserve battery power of the mobile device by first determining a correct alignment for iris authentication utilizing low-power illumination of the dual-mode LEDs. Further, the described features reduce the heat generated in the mobile device by utilizing the low-power illumination of the dual-mode LEDs to illuminate the face of the user and determine the correct alignment before switching to a high-power illumination for imaging. These features minimize use of the IR imager and high-power IR LEDs, which results in a power savings of the device battery power, and also provides an improved user experience with the assisted alignment detection to guide the user of a mobile device.

While features and concepts of low-power iris authentication alignment can be implemented in any number of different devices, systems, environments, and/or configurations, embodiments of low-power iris authentication alignment are described in the context of the following example devices, systems, and methods.

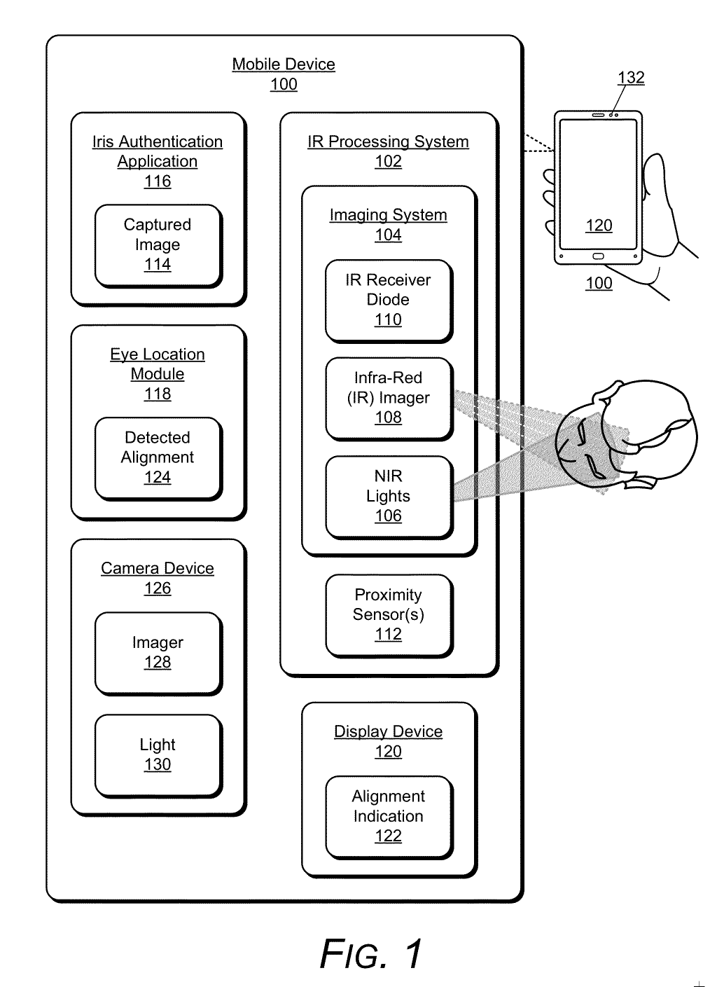

FIG. 1 illustrates an example mobile device 100 in which embodiments of low-power iris authentication alignment can be implemented. The example mobile device 100 may be any type of mobile phone, tablet device, digital camera, or other types of computing and electronic devices that are typically battery powered. In this example, the mobile device 100 implements components and features of an infra-red (IR) processing system 102 that can be utilized for gesture recognition and/or iris authentication of a user of the mobile device. The IR processing system 102 includes an imaging system 104 with near infra-red (NIR) lights 106 (such as LEDs), an IR imager 108, and an IR receiver diode 110. Although shown as a component of the IR processing system 102 in this example, the IR imaging system 104 may be implemented in the mobile device 100 separate from the IR processing system. The IR processing system 102 can also include one or more proximity sensors 112 that detect the proximity of a user to the mobile device.

The NIR lights 106 can be implemented as a LED, or as a system of LEDs, that are used to illuminate features of a user of the mobile device 100, such as for gesture recognition and/or iris authentication, or other NIR-based systems. Generally, the LED system (e.g., of the NIR lights 106) includes one or more LEDs used to illuminate the face of the user, and from which an alignment of the face of the user with respect to the mobile device can be detected. The NIR lights 106 can be used to illuminate the eyes of the user, and the IR imager 108 is dedicated for eye imaging and used to capture an image 114 of an eye (or both eyes) of the user. The captured image 114 of the eye (or eyes) can then be analyzed for iris authentication with an iris authentication application 116 implemented by the mobile device. The mobile device 100 also implements an eye location module 118 that is further described below with reference to features of iris acquisition and authentication.

The iris authentication application 116 and the eye location module 118 can each be implemented as a software application or module, such as executable software instructions (e.g., computer-executable instructions) that are executable with a processing system of the device in embodiments of low-power iris authentication alignment. The iris authentication application 116 and the eye location module 118 can be stored on computer-readable storage memory (e.g., a memory device), such as any suitable memory device or electronic data storage implemented in the mobile device. Although shown as separate components, the eye location module 118 may be integrated as a module of the iris authentication application 116. Further, the iris authentication application 116 and/or the eye location module 118 may be implemented as components of the IR processing system 102.

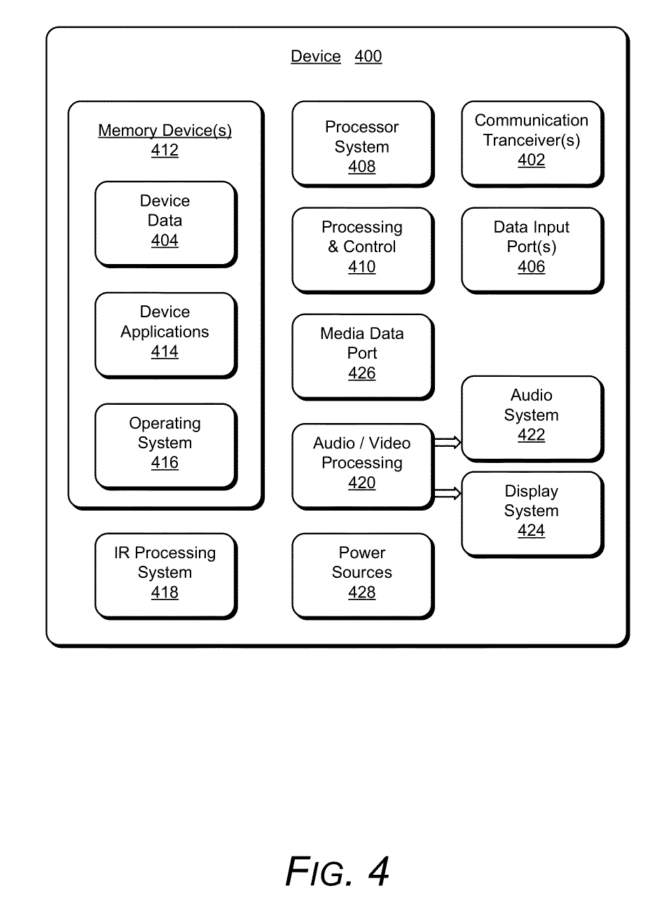

Additionally, the mobile device 100 can be implemented with various components, such as a processing system and memory, an integrated display device 120, and any number and combination of various components as further described with reference to the example device shown in FIG. 4. As further described below, the display device 120 can display an alignment indication 122, such as displayed in an interface of the IR processing system 102. The alignment indication 122 can indicate a direction to turn the device and assist a user of the mobile device 100 with achieving a correct alignment of the face of the user with respect to the mobile device so that an image of an eye (or eyes) of the user can be captured for iris authentication by the iris authentication application 116. The alignment indication 122 can be initiated and displayed based on a detected alignment 124 by the eye location module 118.

In this example, the mobile device 100 also includes a camera device 126 that is utilized to capture digital images, and the camera device 126 includes an imager 128 to capture a visible light digital image of a subject. In alternate implementations, the IR imager 108 of the IR processing system 102 and the camera imager 128 can be combined as a single imager of the mobile device 100 in a design that may be dependent on IR filtering, imaging algorithm processing, and/or other parameters. The camera device also includes a light 130, such as a flash or LED, that emits visible light to illuminate the subject for imaging. The camera device 126 can be integrated with the mobile device 100 as a front-facing camera with a lens 132 that is integrated in the housing of the mobile device and positioned to face the user when holding the device, such as to view the display screen of the display device 120.

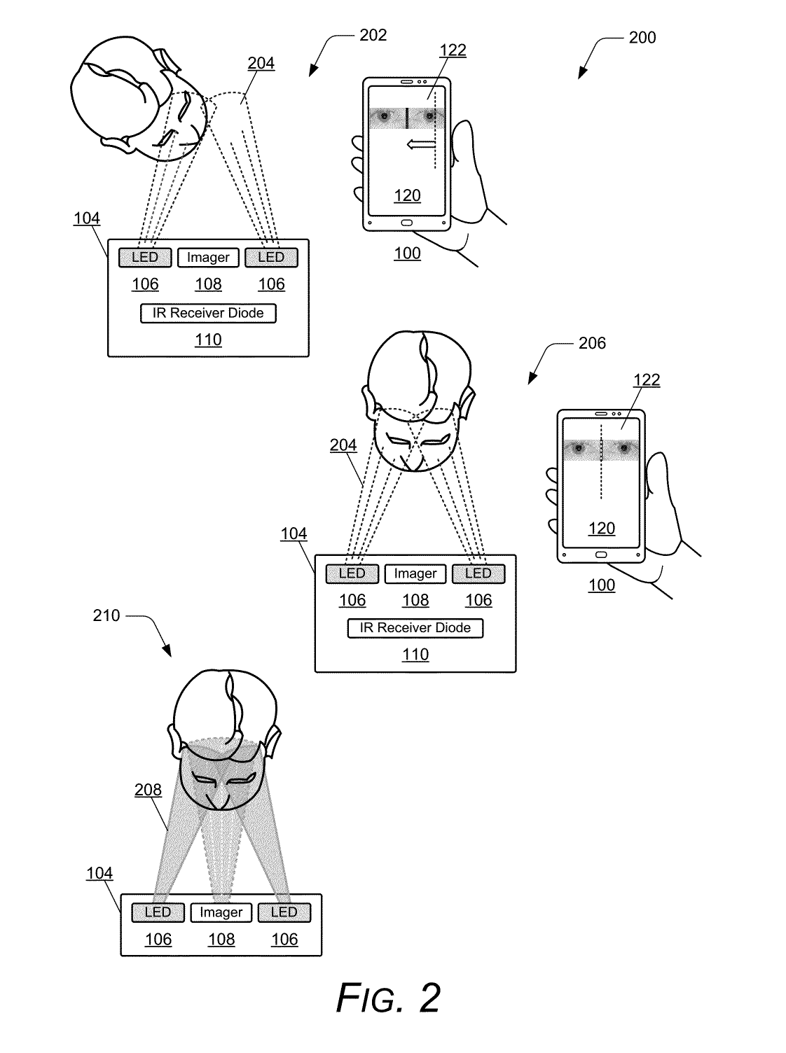

FIG. 2 illustrates examples 200 of low-power iris authentication alignment as described herein. As shown at 202, the imaging system 104 of the mobile device 100 includes the IR imager 108 and an LED system (e.g., of the NIR lights 106) that are used to illuminate the face of a person (e.g., a user of the mobile device 100). As described above, the LED system of the NIR lights 106 can include one or more LEDs used to illuminate the face of the user, and from which the alignment of the face of the user with respect to the mobile device can be detected by assessing an origin of the emitted lights, where two or more of the LEDs are serialized and each LED transmits in a dedicated time slot in a time-division multiple access (TDMA) system. Based on an assessment of all the reflected LED lights, the system detects whether the head of the user is in the desired viewing angle. In this current implementation, all of the LEDs can transmit the same pulse, but in different time slots. In other implementations, the LEDs are designed to each transmit a unique code (e.g., a unique LED signature).

In implementations, the eye location module 118 can receive a sensor input from a proximity sensor 112 that indicates a proximity of the user to the mobile device 100, such as when the user approaches the device and/or picks up the device. The eye location module 118 can then initiate alignment detection of the face of the user utilizing low-power illumination 204 based on the detected proximity of the user.

In this example shown at 202, the low-power illumination 204 is shown as a dashed-line field of illumination from each of the LEDs (e.g., the NIR lights 106). Additionally, the LED system in the described implementation can include dual-mode LEDs that are configured for the low-power illumination 204 to illuminate the face of the user, and can then be switched for high-power illumination to illuminate an eye (or both eyes) of the user for iris authentication. Alternatively, two discrete LED sets can be used, one LED of each set for high-power illumination, and the other for the low-power illumination.

The eye location module 118 determines the alignment 124 of the face of the user with respect to the mobile device 100 based on the reflections of the low-power illumination 204 from the dual-mode LEDs (e.g., the NIR lights 106 reflected from the user). Two or more of the LEDs illuminate the face of the user, and the IR receiver diode 110 receives the reflected light, from which the origins of the reflected light are assessed to determine an orientation of the head of the user. As shown at 202, the face of the user is not aligned with the imaging system 104 of the mobile device 100, and the alignment indication 122 is displayed in an interface on the display device 120 of the mobile device. Here, the alignment indication is shown as a dashed line with an arrow to direct the user which way to move the mobile device so that the dashed line is centered between the eyes as displayed in a preview of the eyes (e.g., a video preview or a still image preview). As shown at 206, the alignment indication 122 assists the user of the mobile device 100 with achieving a correct alignment of the face of the user with respect to the device so that an image of an eye (or eyes) of the user can be captured for iris authentication by the iris authentication application 116.

At 206, the alignment indication 122 that is displayed in the interface on the display device 120 of the mobile device 100 shows a correct alignment of the face of the user with respect to the mobile device, and the eye location module 118 can determine the correct alignment for iris authentication. As described, these features of low-power iris authentication alignment conserve battery power of the mobile device 100 by determining the correct alignment for iris authentication utilizing the low-power illumination 204 of the dual-mode LEDs (e.g., the NIR lights 106). Further, the described features reduce the heat generated in the mobile device by utilizing the low-power illumination of the dual-mode LEDs to illuminate the face of the user and determine the correct alignment.

When the eye location module 118 determines the correct alignment for iris authentication as shown at 206, the eye location module 118 can initiate the LED system of the one or more dual-mode LEDs (e.g., the NIR lights 106) for high-power illumination 208 of an eye (or both eyes) of the user as shown at 210. Further, based on the determination of the correct alignment, the eye location module 118 can also activate the IR imager 108 to capture an image of the eye (or eyes) of the user as the captured image 114 for iris authentication by the iris authentication application 116.

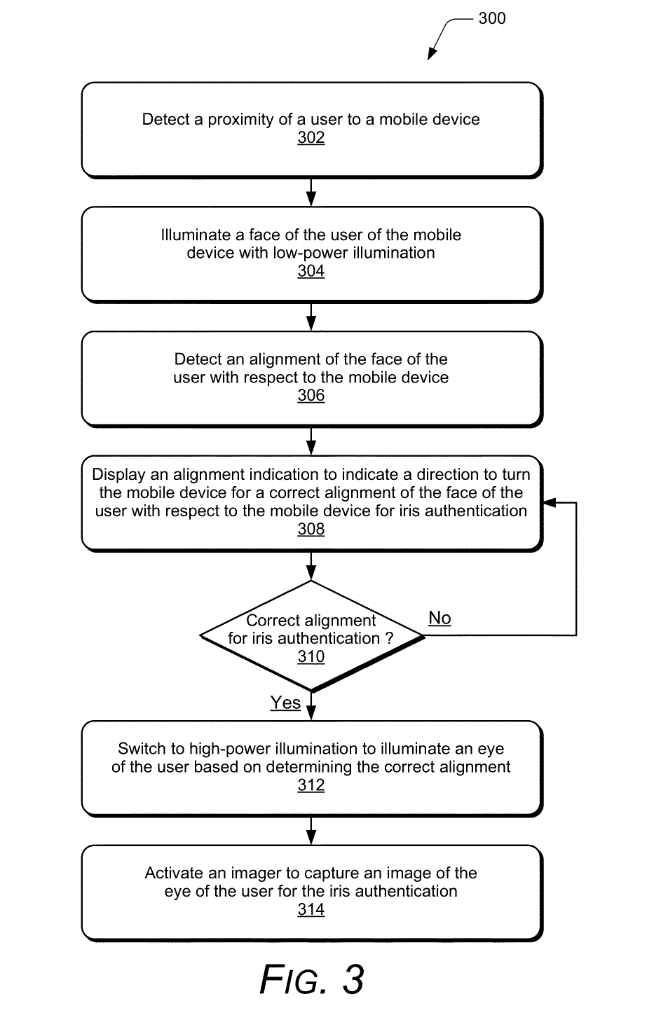

Example method 300 is described with reference to FIG. 3 in accordance with implementations of low-power iris authentication alignment. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of low-power iris authentication alignment. The order in which the method is described is not intended to be construed as a limitation, and any number or combination of the described method operations can be performed in any order to perform a method, or an alternate method.

At 302, a proximity of a user to a mobile device is detected and, at 304, a face of the user of the mobile device is illuminated with low-power illumination. For example, a proximity sensor 112 of the mobile device 100 (FIG. 1) detects a proximity of a user to the mobile device, and the eye location module 118 initiates utilizing the low-power illumination 204 (FIG. 2) to illuminate the face of the user of the device. In implementations, the face of the user is illuminated with a multi-LED system of at least two LEDs from which the alignment of the face of the user is detected by the eye location module 118. The dual-mode LEDs (e.g., the NIR lights 106) can be implemented for the low-power illumination to illuminate the face of the user from which the correct alignment is determined, and then switched for high-power illumination and imaging for iris authentication. Utilizing the low-power illumination conserves device battery power and reduces heat that would otherwise be generated in the mobile device by using high-power illumination just to establish a correct alignment of the user with respect to the mobile device.

At 306, an alignment of the face of the user with respect to the mobile device is detected and, at 308, an alignment indication of the mobile device is displayed to indicate a direction to turn the device for a correct alignment of the face of the user with respect to the mobile device for iris authentication. For example, the eye location module 118 that is implemented by the mobile device 100 detects the alignment 124 of the face of the user with respect to the mobile device 100 based on the reflections of the low-power illumination 204 from the dual-mode LEDs (e.g., the NIR lights 106 reflected from the user) as received by the IR receiver diode 110, and the alignment indication 122 is displayed in an interface on the display device 120 of the mobile device.

At 310, a correct alignment for iris authentication is determined based on the detected alignment of the face of the user. For example, the eye location module 118 that is implemented by the mobile device 100 determines whether the user is correctly aligned with respect to the imaging system 104 of the mobile device. The alignment indication 122 that is displayed in the interface on the display device 120 of the mobile device 100 shows a direction to turn the device for a correct alignment of the face of the user with respect to the mobile device (at 206), and the eye location module 118 determines the correct alignment for iris authentication.

If the correct alignment for iris authentication is not determined (i.e., “No” from 310), then the method continues at 308 to display the alignment indication 122 on the display device 120 of the mobile device 100, indicating the alignment adjustment and assisting the user positioning with respect to the mobile device. If the correct alignment for iris authentication is determined (i.e., “Yes” from 310), then at 312, the device switches to high-power illumination to illuminate an eye (or eyes) of the user based on determining the correct alignment. For example, the eye location module 118 that is implemented by the mobile device 100 determines the correct alignment for iris authentication (at 206) and initiates one or more of the LEDs in the LED system of the dual-mode LEDs (e.g., the NIR lights 106) for high-power illumination 208 of an eye (or both eyes) of the user (at 210).

At 314, an imager is activated to capture an image of the eye of the user for the iris authentication. For example, the eye location module 118 that is implemented by the mobile device 100 activates the IR imager 108 to capture an image of the eye (or eyes) of the user as the captured image 114 for iris authentication by the iris authentication application 116.

FIG. 4 illustrates various components of an example device 400 in which embodiments of low-power iris authentication alignment can be implemented. The example device 400 can be implemented as any of the computing devices described with reference to the previous FIGS. 1-3, such as any type of client device, mobile phone, tablet, computing, communication, entertainment, gaming, media playback, and/or other type of device. For example, the mobile device 100 shown in FIG. 1 may be implemented as the example device 400.

The device 400 includes communication transceivers 402 that enable wired and/or wireless communication of device data 404 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 400 may also include one or more data input ports 406 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 400 includes a processing system 408 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 410. The device 400 may further include any type of a system bus or other data and command transfer system that couples the various components within the device. A system bus can include any one or combination of different bus structures and architectures, as well as control and data lines.

The device 400 also includes computer-readable storage memory 412 that enable data storage, such as data storage devices that can be accessed by a computing device, and that provide persistent storage of data and executable instructions (e.g., software applications, programs, functions, and the like). Examples of the computer-readable storage memory 412 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 400 may also include a mass storage media device.

The computer-readable storage memory 412 provides data storage mechanisms to store the device data 404, other types of information and/or data, and various device applications 414 (e.g., software applications). For example, an operating system 416 can be maintained as software instructions with a memory device and executed by the processing system 408. The device applications may also include a device manager, such as any form of a control application, software application, signal-processing and control module, code that is native to a particular device, a hardware abstraction layer for a particular device, and so on. In this example, the device 400 includes an IR processing system 418 that implements embodiments of low-power iris authentication alignment, and may be implemented with hardware components and/or in software, such as when the device 400 is implemented as the mobile device 100 described with reference to FIGS. 1-3. An example of the IR processing system 418 is the IR processing system 102, which also optionally includes the iris authentication application 116 and/or the eye location module 118, that is implemented by the mobile device 100.

The device 400 also includes an audio and/or video processing system 420 that generates audio data for an audio system 422 and/or generates display data for a display system 424. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 426. In implementations, the audio system and/or the display system are integrated components of the example device. Alternatively, the audio system and/or the display system are external, peripheral components to the example device.

The device 400 can also include one or more power sources 428, such as when the device is implemented as a mobile device. The power sources may include a charging and/or power system, and can be implemented as a flexible strip battery, a rechargeable battery, a charged super-capacitor, and/or any other type of active or passive power source.

Although embodiments of low-power iris authentication alignment have been described in language specific to features and/or methods, the subject of the appended claims is not necessarily limited to the specific features or methods described. Rather, the specific features and methods are disclosed as example implementations of low-power iris authentication alignment, and other equivalent features and methods are intended to be within the scope of the appended claims. Further, various different embodiments are described and it is to be appreciated that each described embodiment can be implemented independently or in connection with one or more other described embodiments.

1. A method for low-power iris authentication alignment, comprising:
utilizing low-power illumination to illuminate a face of a user of a mobile device, said utilizing the low-power illumination initiated based on detecting a proximity of the user to the mobile device with a proximity sensor;
detecting an alignment of the face of the user with respect to the mobile device;
determining a correct alignment for iris authentication based on the detected alignment of the face of the user;
switching to high-power illumination to illuminate an eye of the user based on said determining the correct alignment, the high-power illumination utilizing more power to illuminate the eye of the user than the low-power illumination to illuminate the face of the user; and
activating an imager to capture an image of the eye of the user for the iris authentication.

2. The method as recited in claim 1, wherein said utilizing the low-power illumination comprises illuminating the face of the user with a multi-LED system of at least two LEDs from which the alignment of the face of the user is detected.

3. The method as recited in claim 1, wherein a dual-mode LED is utilized for the low-power illumination to illuminate the face of the user from which the correct alignment is determined, and said switching to the high-power illumination of the dual-mode LED to illuminate the eye of the user for the iris authentication.

4. The method as recited in claim 1, further comprising:
conserving battery power of the mobile device by said determining the correct alignment for the iris authentication utilizing the low-power illumination that utilizes less of the battery power than for the high-power illumination.

5. The method as recited in claim 1, further comprising:
reducing heat generated in the mobile device by said utilizing the low-power illumination prior to the high-power illumination to illuminate the eye of the user for the iris authentication.

6. (canceled)

7. The method as recited in claim 1, further comprising:
displaying an alignment indication of the mobile device to indicate a direction to turn the mobile device for the correct alignment of the face of the user with respect to the mobile device for the iris authentication.

8. A mobile device, comprising:
an LED system configured to illuminate features of a user of the mobile device;
a proximity sensor configured to detect a proximity of the user to the mobile device;
a memory and processing system implementing an eye location module that is configured to:
initiate, based on the detected proximity of the user to the mobile device, the LED system for low-power illumination of a face of the user;
detect an alignment of the face of the user with respect to the mobile device;
determine a correct alignment for iris authentication based on the detected alignment of the face of the user;
initiate the LED system for high-power illumination of an eye of the user based on the determination of the correct alignment, the high-power illumination utilizing more power to illuminate the eye of the user than the low-power illumination to illuminate the face of the user; and
activate an imager to capture an image of the eye of the user for the iris authentication.

9. The mobile device as recited in claim 8, wherein the LED system comprises at least two LEDs configured for the low-power illumination from which the eye location module is configured to detect the alignment of the face of the user with respect to the mobile device.

10. The mobile device as recited in claim 8, wherein the LED system comprises a dual-mode LED configured for the low-power illumination to illuminate the face of the user and configured to switch for the high-power illumination to illuminate the eye of the user for the iris authentication.

11. The mobile device as recited in claim 8, wherein the eye location module is configured to conserve battery power of the mobile device to determine the correct alignment for the iris authentication utilizing the low-power illumination that utilizes less of the battery power than for the high-power illumination.

12. The mobile device as recited in claim 8, wherein the eye location module is configured to reduce heat generated in the mobile device by utilizing the low-power illumination prior to the high-power illumination to illuminate the eye of the user for the iris authentication.

13. (canceled)

14. The mobile device as recited in claim 8, further comprising a display device configured to display an alignment indication of a direction to turn the mobile device for the correct alignment of the face of the user with respect to the mobile device for the iris authentication.

15. A system, comprising:
a dual-mode LED configured for low-power illumination to illuminate a face of a person, and configured for high-power illumination to illuminate an eye of the person, the high-power illumination utilizing more power to illuminate the eye of the person than the low-power illumination to illuminate the face of the person;
a proximity sensor configured to detect a proximity of the person;
a memory and processing system implementing an eye location module that is configured to:
detect an alignment of the face of the person with respect to an imager that is configured to capture an image of the eye of the person, the alignment detection of the face of the person initiated based on the detected proximity of the person;
determine a correct alignment for iris authentication based on the alignment detection of the face of the person utilizing the low-power illumination;
switch the dual-mode LED for the high-power illumination to illuminate the eye of the person based on the determination of the correct alignment; and
activate the imager to capture the image of the eye of the person for the iris authentication.

16. The system as recited in claim 15, further comprising a multi-LED system of at least two LEDs from which the eye location module is configured to detect the alignment of the face of the person.

17. The system as recited in claim 15, wherein the eye location module is configured to conserve battery power of the mobile device to determine the correct alignment for the iris authentication utilizing the low-power illumination that utilizes less of the battery power than for the high-power illumination.

18. The system as recited in claim 15, wherein the eye location module is configured to reduce generated heat by utilizing the low-power illumination prior to the high-power illumination to illuminate the eye of the person for the iris authentication.

19. (canceled)

20. The system as recited in claim 15, wherein the eye location module is configured to initiate display of an alignment indication of a direction to turn the mobile device for the correct alignment of the face of the person with respect to the imager for the iris authentication.

21. The method as recited in claim 1, wherein said detecting the proximity of the user to the mobile device when the user approaches the mobile device.

22. The method as recited in claim 1, wherein said detecting the proximity of the user to the mobile device when the user touches the mobile device.

23. The mobile device as recited in claim 8, wherein the proximity sensor is configured to detect the proximity of the user to the mobile device when the user approaches the mobile device.
